(19) United States
(12) Patent Application Publication
(10) Pub. No.: US 2022/0389940 A1
(43) Pub. Date: Dec. 8, 2022

(54) ATTACHABLE DUST FILTER FOR A CONVENTIONAL CIRCULATION FAN

(71) Applicant: Dao Hoang Vo, Renton, WA (US)

(72) Inventor: Dao Hoang Vo, Renton, WA (US)

(73) Assignee: Toan Thien Vo, Renton, WA (US)

(21) Appl. No.: 17/336,320

(22) Filed: Jun. 2, 2021

(51) Int. Cl. F04D 29/70; F04D 19/00; B01D 46/42; B01D 39/08

(52) U.S. Cl. CPC F04D 29/703; F04D 19/002; B01D 46/4227; B01D 39/08; B01D 2273/30

(57) ABSTRACT

An attachable air filter medium for attachment to a conventional circulation fan is disclosed comprising a netting fabric filter medium being adapted to fit over the rear half of the conventional circulation fan's housing for filtering dust particles in air coming into the circulation fan preventing dust buildup on the fan blade thus eliminate the need to periodically clean the fan.

### BACKGROUND OF THE INVENTION

The invention relates to a removable, auxiliary dust filter for a circulation fan that is used to prevent dust buildup on the fan blade and thus eliminate the need to clean the fan blade periodically.

Currently there is no way to prevent dust buildup on the circulation fan blade. Dirty air with dust particle enter the circulation fan from the rear and exit at the front of the fan. During the fan's operation, dust particles collect on the fan blade becoming more visible over time and require periodic cleaning of the fan blade. Cleaning the fan blade is a tedious and time consuming task involving the disassembly of the circulation fan's housing assembly, cleaning the blade and reassemble the housing assembly.

The objectives of the invention is to eliminate or reduce the periodic cleaning of the fan blade. As air being pulled into the fan from the rear by the fan blade, installing a filter medium to filter dust particle prior to delivery to the front of the fan would significantly reduce the amount of dust particles being pulled into the fan. An attachable air filter medium for attachment to a circulation fan comprising a netting fabric filter medium being adapted to fit over the rear half of the circulation fan's housing for filtering air coming into the circulation fan and allowing clean air to exit in front of the circulation fan to prevent or reduce dust buildup on the fan blade thus prolong the periodic cleaning of the fan blades or eliminate the periodic cleaning if filter is changed to recommended frequency.

### DESCRIPTION OF THE DRAWINGS

The invention will be more readily understood from a reading of the following specification and by reference to the accompanying photos forming a part thereof, wherein an example of the invention is shown and wherein:

FIG. 1 is a perspective view of a supplemental, attachable filter constructed according to the invention fitted over a conventional circulation fan.

FIG. 2 is a perspective view of a supplemental filter constructed according to the invention being separated from a conventional circulation fan.

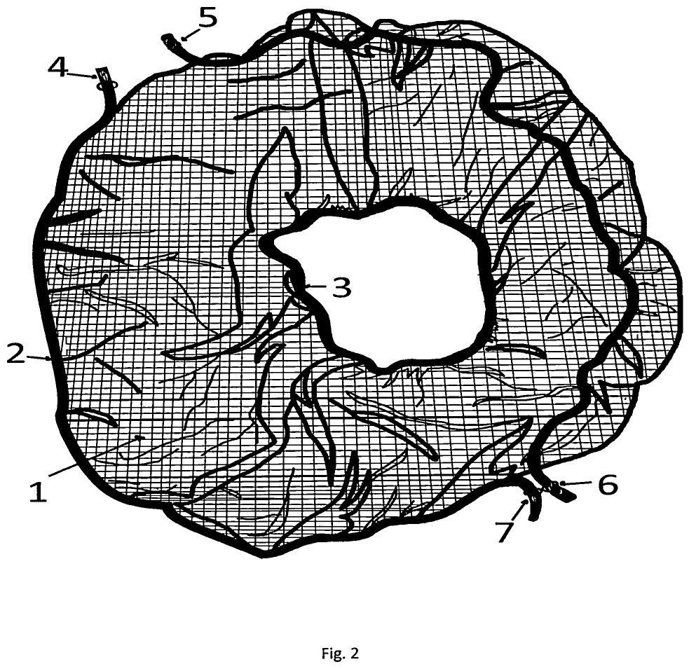

### DESCRIPTION OF A PREFERRED EMBODIMENT

Referring now to the drawing. the invention will be described in more detail,

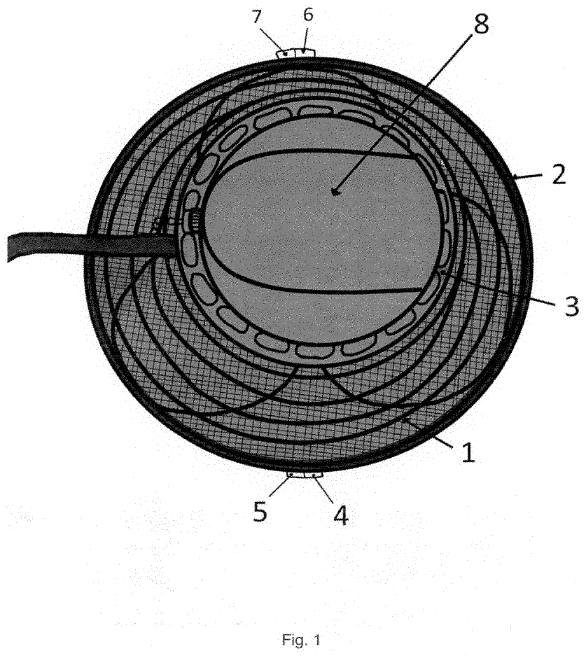

As can best be seen in FIG. 1, the invention, a filter medium is shown attached to the rear half of the circulation fan housing. The filter comprising:

A doughnut shape piece of netting type fabric (1) with elastic bands stitched on the outer (2) and inner (3) rings. Hooks (4,7) and hook receivers (5,6) are attached on the outer elastic bands. Inner ring (3) can be of different sizes to accommodate various motor housings. A continuous piece of netting fabric (without inner ring) can be used for motor housing that does not protrude too far from the surface of the fan housing.

The filter medium is attached to the rear half of the circulation fan to prevent dust particles from entering the fan and collect on the fan's blades.

Preferably, the filter medium is affixed to the circulation fan by way of elastic bands (2,3) stitched to the filter would fit over the flange where the two halves of the fan housing are joined and another stitched elastic band fit over the motor housing (8) to prevent the filter from detachment from the fan housing or being pulled into the fan during operation. Attached hooks on the outer elastic bands (4,7) and hook receivers (5,6) are used to secure filter around fans attached to wall or ceiling mounts.

The invention provides the elimination or reduction of dust particles being pulled through the rear of the fan. The filter is placed in a key location that is most sensible when desiring to be most effective. In gyms, athletic facilities where circulation fans are frequently used, the sight of a dirty circulation fan would raise questions regarding the cleanliness and air quality of the facility. At home, a dirty circulation fan is found to be un-attractive.

Thus, it can be seen that a simple, add-on filter can be had according to the invention that will work universally at home, offices, athletic facilities to provide clean circulation fans. The color of the filter medium can be decorative and easy way to indicate if the filter needs to be changed.

While the preferred embodiment of the invention has been described using specific terms, such description is for illustrative purposed only, and it is to be understood that changes and variations may be made without departing from the spirit or scope of the following claims.

What is claim is:

1. An attachable circulation fan air filter assembly for attachment to a circulation fan comprising a doughnut shape piece of netting type fabric with elastic bands stitched on the outer and inner rings.

2. The assembly of claim 1 is attached to the rear half of the circulation fan. The smaller elastic band secures the filter around the motor housing while the larger elastic band secures the filter to the perimeter flange where front and rear halves of the circulation fan housing are joined.

3. The assembly of claim 2 includes hooks and hook receivers attached on the outer elastic bands are used to secure filter around fans attached to wall or ceiling mounts.

4. The assembly of claim 1 can also be comprised of a continuous piece of netting fabric. The filter medium without the inner ring can be used for non-protruding motor housing.

5. The assembly of claim 1 is adaptable to various fan's sizes.

6. The assembly of claim 1 can also be of various mesh size openings to collect different types of dust particles.

7. The assembly of claim 1 does not significantly reduce air flow through the fan.

8. The assembly of claim 1 primary objective is to prevent or reduce dust particles from being pulled into the fan from the rear and collect on the fan blade, thus eliminate or reduce periodical cleaning of the fan and fan blade.
